(19) United States
(12) Patent Application Publication
(10) Pub. No.: US 2019/0202424 A1
(43) Pub. Date: Jul. 4, 2019

(54) BRAKE POWER MEASURING DEVICE

(71) Applicants: Matthew Curtis Miller, Palerston North (NZ); Philip William Fink, Palmerston North (NZ); Rolf V. Ostergaard, Copenhagen (DK); Morten Kristiansen, Allerod (DK); Benjamin Holm Salka, Kobenhavn V (DK)

(72) Inventors: Matthew Curtis Miller, Palerston North (NZ); Philip William Fink, Palmerston North (NZ); Rolf V. Ostergaard, Copenhagen (DK); Morten Kristiansen, Allerod (DK); Benjamin Holm Salka, Kobenhavn V (DK)

(21) Appl. No.: 16/311,636

(22) PCT Filed: Jun. 23, 2017
(86) PCT No.: PCT/NZ2017/050085

§ 371 Date: Dec. 19, 2018

(30) Foreign Application Priority Data
Jun. 24, 2016 (NZ) 721507
Sep. 15, 2016 (NZ) 724361

(51) Int. Cl. B60T 8/32; B60T 8/52

(52) U.S. Cl. CPC B60T 8/329; G01L 3/24; B60T 8/52

(57) ABSTRACT

A brake power measuring device (100) for use with a vehicle having a braking system. The device has a housing attachable to, or attached to, a brake disc, or to a frame near a brake caliper of the braking system. The housing houses one or more force sensing elements (220) for measuring a force experienced by the brake disc or frame during braking. A control unit (230) is configured to receive the measured force, calculate power losses as a result of braking, based on the measured force and data representing angular velocity, and produce the power loss calculations as output data

### RELATED APPLICATIONS

This application is a National Stage of International Application No. PCT/NZ2017/050085, filed Jun. 23, 2017, which claims priority of New Zealand Provisional Patent Application No. 724361, filed Sep. 15, 2016 and New Zealand Provisional Patent Application No. 721507, filed Jun. 24, 2016.

### TECHNICAL FIELD

The present disclosure generally relates to a brake power measuring device for use with a vehicle, such as a bicycle, motor bike, car, or truck for example.

### BACKGROUND INFORMATION

In the field of bicycle training and racing, a number of objective and subjective performance parameters may be used to judge the level and quality of a cyclist's performance in a particular event or training activity. These parameters may also be used to determine the degree to which the cyclist's overall ability, or specific aspects of the cyclist's ability, were utilized in an event or training session. This information can then be used to tailor specific approaches to future events or training activities for the cyclist.

Bicycle power meters are being increasingly used by both professional and amateur cyclists as an aid in developmental training and performance analysis. These power meters measure the mechanical propulsive power generated by the cyclist that enables the bicycle to move forward. Mechanical propulsive power meters typically fall into one of two basic categories: devices that measure torque and angular velocity in driving components of a bicycle, such as pedals and crank arms; and devices that measure torque and angular velocity in driven components, such as the chain rings, chain and rear wheel.

Another performance parameter is the cycling skill of a cyclist. However, to date it has been impossible to quantify this skill. One method that could help to quantify skill could be measuring the cyclist's use of brakes. To maintain a perceived safe speed, the cyclist uses the brakes to reduce the forward velocity and slow the bicycle down. If the cyclist brakes hard and suddenly, the bicycle may enter into an uncontrolled skid. Similarly, if the cyclist brakes too hard, albeit slowly, the bicycle may be slowed too much and valuable speed may be lost, especially during a cycling race. In both scenarios, the cyclist needs to work hard to bring the bicycle back to its original pre-braking speed. To improve energy conservation, cyclists should therefore aim to reduce the risk of braking too hard or for too long.

Similar problems arise with other vehicles, such as motor vehicles, including cars, trucks and motorbikes. Again, with these vehicles, when the driver brakes too hard, the vehicle may be at risk of skidding or of slowing too much so as to lose valuable time. In addition, by overly reducing the momentum of the vehicle, fuel is used to bring the vehicle back up to speed and this also takes time. Any fuel and time that is used as a result of unnecessary braking, such as braking too hard or for too long, may be considered to be wasted.

For both bicycles and motor vehicles, excessive braking can also cause undue wear on the brake parts and tires of the vehicle.

This disclosure describes a brake power measurement device that goes at least some way toward overcoming the disadvantages of the prior art, and/or that at least provides the public with a useful alternative.

### SUMMARY OF THE DISCLOSURE

In accordance with a first aspect of the present disclosure, there is provided brake power measuring device for use with a vehicle comprising a braking system, the device comprising: one or more sensors comprising one or more strain sensors for sensing strain applied to a brake disc during braking; a housing attachable to, or attached to, the brake disc, the housing housing electronics comprising the one or more strain sensors, wherein the one or more strain sensors are configured to generate electronic signals when force is applied to the brake disc during braking; and a control unit configured to: calculate power losses as a result of braking, using torque and angular velocity calculated on the basis of readings from the one or more sensors, and produce the power loss calculations as output data.

In an embodiment, the brake power measuring device further comprises a speed sensor for measuring the angular velocity of the brake disc during braking. In an embodiment, the speed sensor is housed in the housing.

In an embodiment, the one or more strain sensors determines the angular position of the brake disc and the control unit is further configured to receive the angular position and calculate the angular velocity based on the angular position.

In an embodiment, the housing is a substantially enclosed housing.

In an embodiment, the brake power measuring device further comprises comprising a transmitter for transmitting the output data to a user interface.

In an embodiment, wherein the transmitter is a Bluetooth transmitter or ANT transmitter.

In an embodiment, the brake power measuring device further comprises comprising a memory for storing the output data.

In an embodiment, the brake power measuring device further comprises an amplifier configured to amplify readings from the one or more strain sensors before the readings are received by the control unit.

In an embodiment, the speed sensor comprises an accelerometer for measuring the angular velocity of the disc.

In an embodiment, the speed sensor comprises a magnetometer for measuring the angular velocity of the disc.

In an embodiment, the brake power measuring device further comprises an inertial measurement unit, which comprises an accelerometer, magnetometer and/or gyroscope to measure the angular velocity of the disc.

In an embodiment, the one or more strain sensors comprises one or more strain gauges.

In an embodiment, the brake power measuring device further comprises a brake disc to which the housing is attached.

In an embodiment, the brake power measuring device is configured to be used with a bicycle, car, truck, or motorbike that comprises a disc braking system.

In accordance with a second aspect of the present disclosure, there is provided a brake power measuring device for use with a vehicle comprising a frame, a wheel rotatable relative to the frame, and a braking system associated with the wheel, the device comprising: a housing attachable to the frame near a brake caliper of the braking system, the housing housing one or more force sensing elements for measuring a force experienced by the frame during braking; a speed sensor for measuring the angular velocity of the wheel during braking; a control unit configured to: receive the measured force and the angular velocity, calculate power losses as a result of braking, based on the measured force and angular velocity, and produce the power loss calculations as output data.

In an embodiment, the brake power measuring device further comprises further comprising a transmitter for transmitting the output data to a user interface. In an embodiment, the transmitter is a Bluetooth transmitter or ANT transmitter.

In an embodiment, the brake power measuring device further comprises a memory for storing the output data.

In an embodiment, the brake power measuring device further comprises an amplifier configured to amplify readings from the one or more force sensing elements before the readings are received by the control unit.

In an embodiment, the speed sensor comprises an accelerometer for measuring the angular velocity of the wheel.

In an embodiment, the speed sensor comprises a magnetometer for measuring the angular velocity of the wheel.

In an embodiment, the brake power measuring device further comprises an inertial measurement unit, which comprises an accelerometer, magnetometer and/or gyroscope to measure the angular velocity of the disc.

In an embodiment, the device is attachable between, or attached between, a brake calliper and a part of the frame.

In an embodiment, the device is an integral or removable part of the caliper.

In an embodiment, the device is an integral or removable part of the frame.

In an embodiment, the device is configured to be used with a bicycle, car, truck, or motorbike that comprises a disc braking system.

There is disclosed a brake power measuring device for use with a vehicle that comprises a braking system. The device may comprise a power meter comprising one or more load cells for measuring strain applied to a brake disc during braking. Optionally, the device may further comprise an inertial measurement unit, which comprises an accelerometer, magnetometer and/or gyroscope to measure the rotation of the disc. Optionally, the device may comprise a magnetic sensor to detect the rotation of the disc. The device may further comprise an amplifier to amplify the signals received from the load cell(s) and the accelerometer or inertial measurement unit (if applicable); a control unit comprising a processor for calculating the torque applied to the disc and producing output data; a transmitter to transmit the output data to a user interface; and a housing within which the electronic components of the brake power measurement device may be held.

The device may be used with a bicycle, car, truck, or motorbike that comprises a disc braking system.

There is disclosed a disc for a disc brake, wherein the disc comprises a power measurement device according to the disclosure.

There is disclosed a brake power measuring device for use with a vehicle comprising a braking system, wherein the device comprises electronics comprising: one or more load cells to measure strain applied to a brake disc during braking; and a control unit configured to calculate power losses as a result of braking, wherein the calculations are based on readings from the one or more sensors and to produce the power calculations as output data; and wherein the electronics are housed within a housing configured to be attached to a brake disc or to brake calipers.

Certain terminology may be used in the following description for the purpose of reference only, and thus are not intended to be limiting. For example, terms such as “above” and “below” refer to directions in the drawings to which reference is made.

Terms such as “top”, “bottom”, “upper”, “lower”, “front”, “back”, “left”, “right”, “rear”, and “side” describe the orientation and/or location of portions of the components or elements within a consistent but arbitrary body of reference which is made clear by reference to the text and the associated drawings describing the components or elements under discussion. Moreover, terms such as “first”, “second”, “third”, and so on may be used to describe separate components. Such terminology may include the words specifically mentioned above, derivatives thereof, and words of similar import.

The term “comprising” and derivatives thereof, such as “comprise” and “comprises”, if and when used herein in relation to a combination of features should not be taken as excluding the possibility that the combination may have further unspecified features. For example, a statement that an arrangement “comprises” certain parts does not mean that it cannot also, optionally, have additional parts. In other words, the terms “comprises”, “comprising”, and similar words, are not to be interpreted in an exclusive or exhaustive sense. Instead, they are intended to mean “including, but not limited to”.

Any reference to prior art documents in this specification is not to be considered an admission that such prior art is widely known or forms part of the common general knowledge in the field.

To those skilled in the art to which the disclosure relates, many changes in construction and widely differing embodiments and applications of the disclosure will suggest themselves without departing from the scope of the invention as defined in the appended claims. The disclosures and the descriptions herein are purely illustrative and are not intended to be in any sense limiting. Where specific integers are mentioned herein which have known equivalents in the art to which this disclosure relates, such known equivalents are deemed to be incorporated herein as if individually set forth.

### BRIEF DESCRIPTION OF THE DRAWINGS

These and other features, aspects and advantages of the present disclosure will be described with reference to the following drawings in which:

FIG. 1 is a front view of one form of power meter or brake power measuring device according to the disclosure and showing an electronics housing attached to a disc brake;

FIG. 2 is a perspective view of the power meter or brake power measuring device of FIG. 1;

FIG. 3 is a front view of the power meter or brake power measuring device of FIG. 1 with part of the electronics housing removed;

FIG. 4 is a flow diagram showing one form of operation of the power meter or brake power measuring device of the disclosure;

FIG. 5a is a side view of a first part of one form of housing to be used with a power meter or brake power measuring device of the disclosure;

FIG. 5b is a front view of the first part of the housing of FIG. 5a;

FIG. 5c is another side view of the first part of the housing of FIG. 5a;

FIG. 6a is a side view of a second part of one form of housing to be used with a brake power measuring device of the disclosure;

FIG. 6b is a rear view of the second part of the housing of FIG. 6a;

FIG. 6c is another side view of the second part of the housing of FIG. 6a;

FIG. 7a is a perspective view of one form of assembled housing to be used with a brake power measuring device of the disclosure;

FIG. 7b is another perspective view of the housing of FIG. 7a;

FIG. 8a is a side view of one form of housing attached to one form of disc brake;

FIG. 8b is another side view of the housing and disc brake of FIG. 8a;

FIG. 9a is an exploded side view of the housing and disc brake of FIG. 8a; FIG. 9b is an exploded side view of the housing and disc brake of FIG. 8b; FIG. 10 is a front view of one form of power meter or brake power measuring device of the disclosure;

FIG. 11a is a front view of another form of power meter or brake power measuring device of the disclosure;

FIG. 11b is a perspective view of the power meter or brake power measuring device of FIG. 11a;

FIG. 11c is a schematic side view illustrating the power meter or brake power measuring device of FIG. 11a attached to calipers of a brake;

FIG. 11d is an enlarged perspective view of above illustrating the power meter or brake power measuring device and caliper arrangement of FIG. 11c;

FIG. 12 is a side view of a bicycle having a power meter or brake power measuring device attached to the calipers of both the front and rear wheel brakes;

FIG. 13 is a line graph showing the braking power output of a skilled cyclist who has trained using the power meter or brake power measuring device of the disclosure compared to an unskilled cyclist;

FIG. 14 is a line graph showing the difference in braking power output of a single cyclist riding the same run before and after training with the power meter or brake power measuring device of the disclosure;

FIG. 15 is perspective view of another form of power meter or brake power measuring device meter of the disclosure;

FIG. 16 is a front view of the power meter or brake power measuring device of FIG. 15, without the cover;

FIG. 17 is a front view of the power meter or brake power measuring device of FIG. 15, without the cover;

FIG. 18 is an exploded view of the housing and disc of the power meter or brake power measuring device of FIG. 15;

FIG. 19 is a perspective view of another form of the power meter or brake power measuring device of the disclosure on a front fork of a bicycle;

FIG. 20 is a perspective view from one side of a body of the power meter or brake power measuring device of FIG. 19;

FIG. 21 is a perspective view from the other side of the power meter or brake power measuring device of FIG. 20;

FIG. 22 is a side view of the power meter or brake power measuring device housing;

FIG. 23 is an view of the battery and PCB of the power meter or brake power measuring device of FIG. 19;

FIG. 24 shows a strain gauge that can be used in the power meter or brake power measuring devices of embodiments of the disclosure, and which may measure strain in two perpendicular directions as indicated by the arrows in the figure.

FIG. 25 shows two graphs:

FIG. 26 is a graph showing calibrated torque;

FIG. 27 is a graph showing the torque contribution of the individual strain gauges;

FIG. 28 is a graph showing the actual angle and the calculated angle.

### DETAILED DESCRIPTION OF EMBODIMENTS

The present disclosure relates to a power meter for measuring the braking power experienced by or applied to an article using a brake, such as to a vehicle. The power meter may also be referred to in this specification as a brake power measuring device. The power meter may be particularly useful for measuring the braking power experienced by or applied to a bicycle, car, truck, or motorbike. For ease of simplicity, forms of power meter according to the disclosure will be described in relation to its use on a bicycle. However, it should be appreciated that the power meter of the disclosure may be used with any other vehicle or article that uses a braking system, particularly a disc braking system.

The power meter is configured to measure the negative power associated with braking. In particular, the power meter is configured to measure the negative power associated with a brake component (for example a brake caliper) as it applies a braking force on another component (for example a disc or a rim) of a bicycle. The power may be the torque experienced by the other component (disc) of the bicycle over time. The power may be measured on the component that receives or experiences the force. Alternatively, the power may be measured on a fixed component. In this embodiment, the force measured will be the force experienced by the fixed component as a result of the braking force being applied. The fixed component/frame may be any substantially rigid part of the bicycle, such as the frame of the bicycle.

The power meter is also configured to measure angular velocity of the brake disc, rotor or wheel.

By measuring the difference in torque calculated before and after braking, it is possible to calculate the likely power loss to the bicycle as a result of braking. Power can be defined as the product of torque τ and angular velocity ω.

P=τ×ω

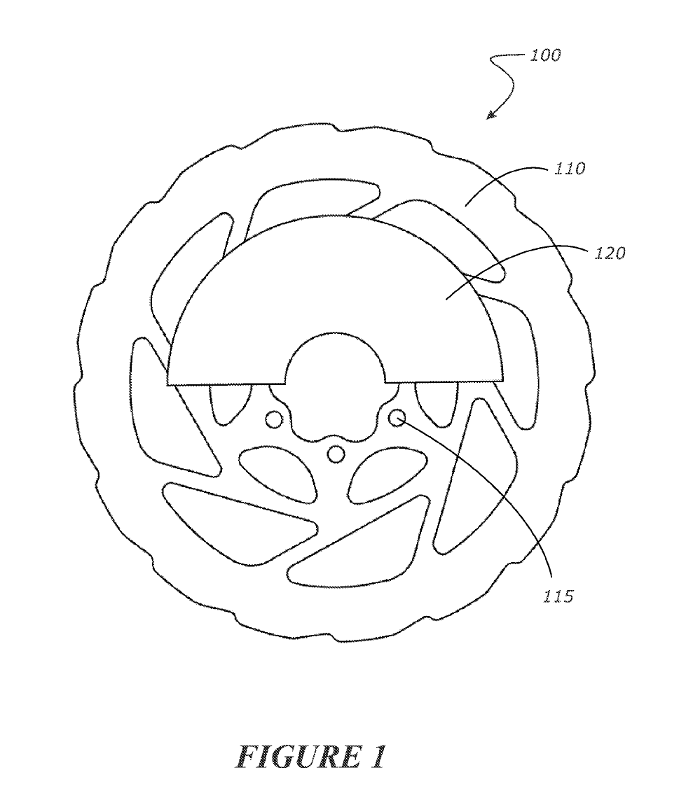

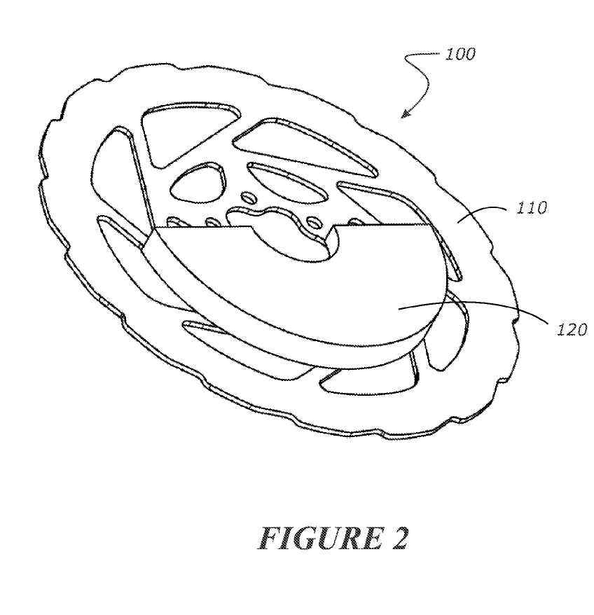

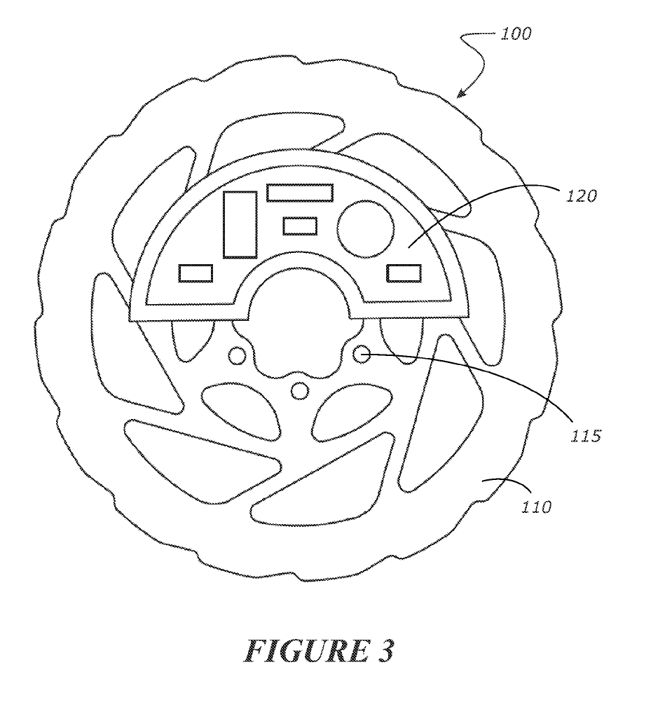

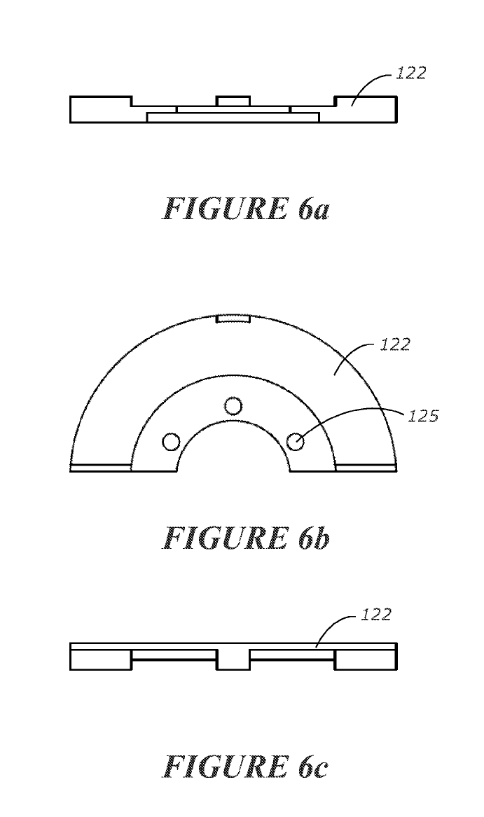

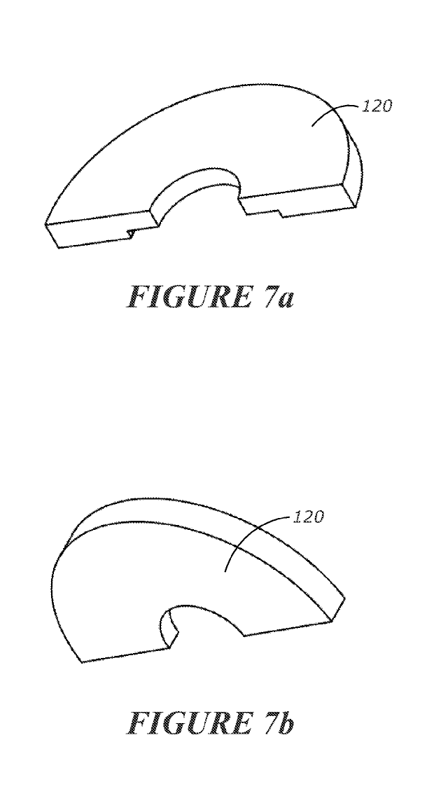

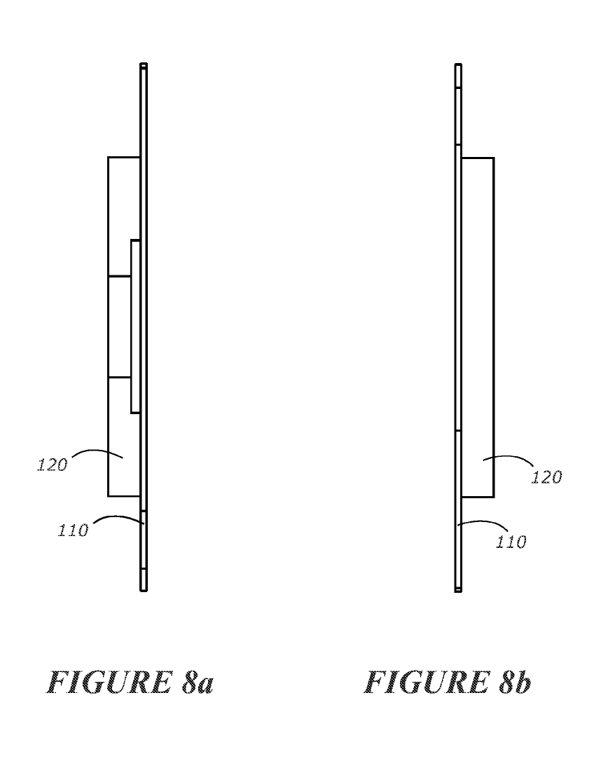

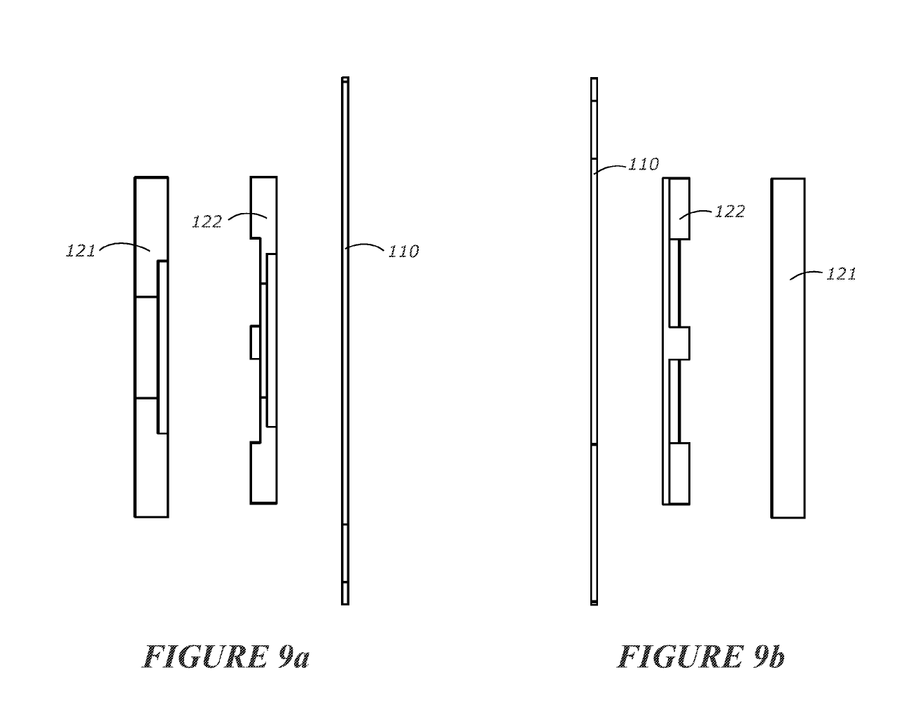

In one form, as shown in FIGS. 1 to 10, the power meter 100 of the disclosure is configured to measure the braking power experienced by or applied to a brake disc or rotor 110 and may be attached to the brake component/brake disc.

The power meter 100 of an embodiment of the disclosure comprises an electronics housing 120 for attaching to the disc 110, and an electronic system 200 for measuring the braking power experienced by, or applied to, the disc 110. The housing houses one or more force sensing elements (strain sensors) for measuring force experienced by the brake disc during braking. The force may be measured by measuring the strain experienced by the brake disc during braking. The force sensing element(s) may be load cell(s) or strain gauge(s), for example. The device also has a speed sensor for measuring the angular velocity of the brake disc during braking. The speed sensor may be housed in the housing or attached to another part of the vehicle, such as the wheel. The speed sensor may comprise more than one component. One speed sensor component may be attached to a wheel or the housing and the other part may be attached to the vehicle frame. All or part of the electronic system 200 may be held within the electronics housing 120.

The housing 120 may be of any suitable form for attaching to a brake disc 110 in any suitable way, such as by bolts, rivets, adhesive, or over-moulding for example. In one form, at least a part of the housing may be integrally formed with the brake disc.

The housing 120 is a substantially enclosed housing. In one form, the housing 120 is a sealed or sealable housing to provide a watertight environment for the electronic system 200.

Optionally, the housing 120 is formed in at least two parts: a first part 121 and a second part 122.

The first part 121 of the housing forms a base on or in which electronic components of the electronic system 200 may be held.

The second part 122 may form a cover, lid, cap, or the like for the housing 120. In one embodiment, the second part 122 may form a cover for the housing and may sit on top of the first part 121. In this arrangement, the second part 122 may be thought of as an upper part to the housing 120. However, it is envisaged that the second part may alternatively form a side cover that covers the side of the housing 120, for example. In this form, the first part may form a substantially hollow enclosure into and out of which the electronics may be slid. The second part of the housing may be placed over the end of the enclosure to form an end cap. These are just some examples of housing arrangements. Other arrangements may alternatively be used without departing from the scope of the disclosure.

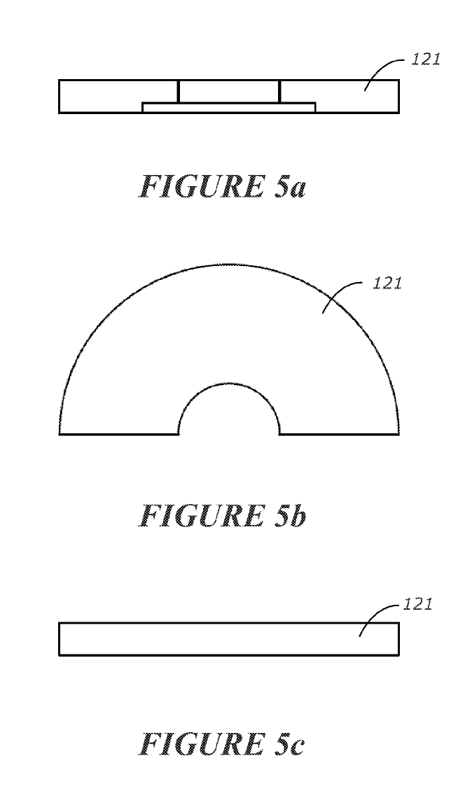

In one form, as shown in FIGS. 5a to 9b, the first 121 and second 122 parts of the housing 120 are substantially semicircular in shape. In one form, the housing comprises a central cutout in which a wheel hub or axle may be located.

The electronics within the housing 120 may include an electronic system 200 comprising a power supply 210, such as a battery, for providing power to the electronic components. In some embodiments, battery is held within an easily accessible location in the housing so that the battery can be readily recharged or replaced. In one form, the electronic circuitry within the housing 120 comprises a battery charger.

The electronics may also include: one or more force sensing elements 220, such as load cells or strain gauges 221, for sensing the strain experienced by or applied to the brake disc by a brake and generating signals based on the strain sensed; and a control unit 230 comprising a memory and being configured for receiving signals from the sensor(s). The electronics also include features to measure the angular velocity of the disc brake. For example, the power meter may comprise an accelerometer 222, gyroscope 224, and/or magnetometer 223. A magnetometer senses repeating patterns from the shape of the brake disc/rotor and/or magnet(s) placed on the brake disc/rotor. These sensors may be separate components or may be some of the integrated circuits used on the printed circuit board.

Alternative velocity sensors include optical sensors or magnet/reed relay/magnetometer/pickup coil based sensors. Further options include capacitive or inductive sensors.

The accelerometer(s) 222 and/or magnetometer(s) 223 and/or gyroscope 224 are examples of sensors 220 that may be used in addition to the one or more force sensing elements /strain gauges 220 of the power meter.

In another form, the power meter 100 may comprise a sensor in the form of an inertial measurement unit 225 comprising one or more of an accelerometer 222, a magnetometer 223, and a gyroscope 224 to measure the rotation of the brake disc 110. In some embodiments, the inertial measurement unit comprises two of the accelerometer, the magnetometer, the gyroscope. In some embodiments, the inertial measurement unit comprises all three of the accelerometer, the magnetometer, the gyroscope. Alternatively or additionally, the power meter 100 may comprise a magnetic sensor to detect rotation of the brake disc and wheel.

All of the electronics may be in the housing. Alternatively, some of the electronics may be in the housing with other electronics external to the housing. The electronics that are external to the housing may be housed in other housings, and will be attached to a suitable part of the bicycle, for example, a wheel, a fork, or other part of the frame.

The control unit 230 is configured to: i. receive the measured force experienced by or applied to the brake disc and the angular velocity of the brake disc, ii. calculate power losses as a result of braking, based on the measured force and angular velocity, and iii. produce the power loss calculations as output data.

In one form, the control unit is configured to receive the measured strain experienced by or applied to the brake disc and calculate power losses as a result of braking, based on the measured strain.

In one form, the electronics system may comprise a transmitter 240 for transmitting output data to a user interface.

In one form, the control unit 230 comprises a clock. The control unit 230 may be configured to control the time intervals between sensor readings, so that the sensors 220 take readings continuously or at predetermined time intervals. For example, the control unit 230 may be programmed to cause the sensors to take readings every 0.1 to 0.5 seconds.

In one form, the control unit 230 comprises a processor, such as a microprocessor, configured to calculate the braking power experienced by or applied to the brake disc and to produce output data based on those calculations. In one form, the braking power may be calculated based on readings from one or more sensors 220 configured to measure angular velocity and one or more sensors configured to measure torque.

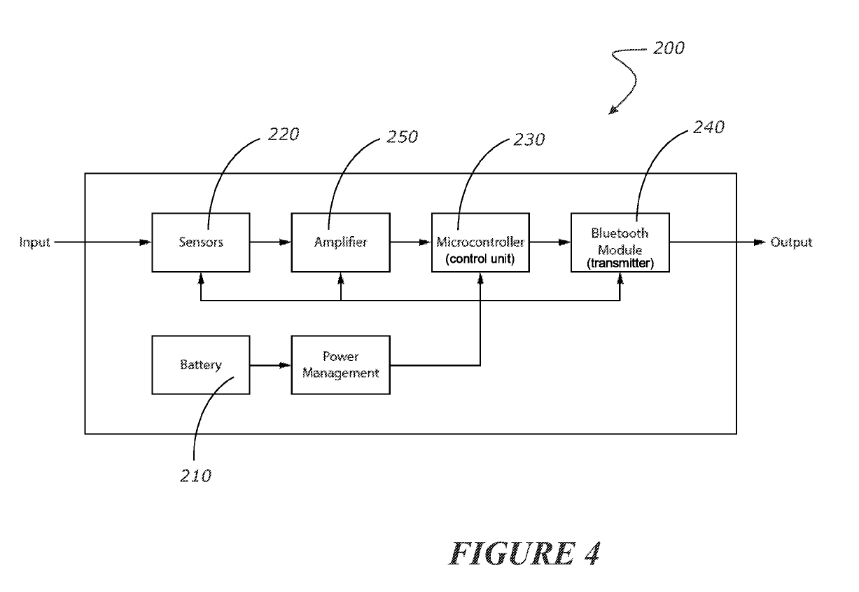

FIG. 4 shows one possible arrangement of electronic components that may be used with the power meter 100 of the disclosure.

In one form, one or more force sensing elements 220 in the form of strain gauges assemblies are mounted on the brake disc 110 to sense the strain experienced by or applied to the disc 110 by the brake. The sensor(s) is/are configured to take readings from the disc 110 and to generate electronic signals when force is experienced by or applied to the disc. The sensor(s) 220 may take readings from the disc 110 constantly or at predetermined time intervals. The sensor readings are sent to the control unit 230. In one form, the power meter 100 may also comprise an amplifier 250 for amplifying the sensor readings before the readings are received by the control unit 230.

Each strain gauge assembly 220 is, in some embodiments, a single foil with two strain gauges. The strain gauges extend at 90 degrees relative to each other and each strain gauge has a length and a width. Each strain gauge measures strain along its length. By combining the readings from both strain gauges, the strain experienced by the disc can be calculated.

Where the power meter comprises a processor, the processor may be configured to receive the electronic signals from the strain gauge(s) 220 and to calculate the magnitude of the torque experienced by or applied to the brake disc and/or to calculate the angular velocity of the disc. In one form, the processor is configured to use the torque and angular velocity calculations to calculate the likely power loss of the bicycle as a result of braking. These calculations may be carried out based on the signals generated from the sensor(s) 220. The calculation(s) may be provided by the processor as output data.

The output data may be stored in memory for transmission/upload to a user interface at a later time or the output data may be immediately wirelessly transmitted to a user interface. If the output data is to be wirelessly transmitted at a later time, the control unit of the power meter may comprise an input button, which may be depressed by a user to cause automatic transmission of the output data. In another form, the control unit may be configured to wirelessly receive an input signal from a remote device to cause automatic transmission of the output data.

In one form, the power meter 100 may comprise a Bluetooth module 240 to wirelessly transmit the output data. Of course other forms of transmitter may be used instead, such as an ANT transmitter for example, but Bluetooth provides for minimal power consumption.

In one form, the power meter may have an output port for connecting the power meter to an external user interface through a wired connection that allows the output data to be uploaded to the user interface.

In some embodiments, the power meter is configured to allow both wireless transmission and wired uploading processes.

In another form, the power meter may be configured to store the sensor readings in its memory. The readings are stored as raw data that may later be wirelessly transmitted or uploaded through a wired connection to an external user interface comprising a processor configured to calculate the torque, angular velocity and/or power loss as described above.

The user interface may be a user's phone, computer, or the like. The user interface may include or be configured to connect to a display screen on which the output data may be displayed in any suitable format, such as a graph or spreadsheet for example. For example, the user interface may be an onboard screen that may be mounted on the bicycle at any suitable location for the cyclist to view the screen whilst cycling. In one form, the user interface may simply be a data storage device comprising a memory that may later be removed by the user for uploading to a user's computer, smartphone, or the like.

The user, who may be the cyclist, a trainer, coach, or other interested person, may review the output data displayed on the user interface to evaluate the skill and performance of the cyclist.

In some forms, the power meter 100 may comprise a GPS unit or may be used in conjunction with a GPS unit or with mapping software so that the user can review the cyclist's performance on a particular track or path. For example, a cyclist may follow a training path that includes uphill sections, flat sections, corners, and downhill sections and the power meter, together with GPS or mapping software, may be used to measure the cyclist's braking throughout this path or at particular sections of the path.

By multiplying the torque applied through the brakes to the rear wheel of the bicycle, and to the angular velocity of one or both wheels, the braking power can be measured and used to quantify the negative work associated with braking. Negative work, which is equal to the change in kinetic energy (AEK) is of importance to a cyclist's performance, training and development. This is because any negative work in excess of that required to control the bicycle will require additional positive propulsive work, which could unnecessarily increase energy expenditure and potentially reduce metabolic efficiency, thus exacerbating glycogen depletion. The extent to which negative work is done is relatable to changes in skill and learning and is independent of a rider's fitness or strength making it an important parameter to be used for training to increase a cyclist's performance.

The power meter 100 of the disclosure may be supplied as an electronic system 200 within a housing 120 that is configured to be attached, by a user for example, to the brake disc 110 of a bicycle. Alternatively, the power meter may be supplied as an electronics housing that is already attached to a brake disc. In this arrangement, the existing bicycle brake disc is removed and swapped with the power meter brake disc 110.

The power meter 100 may be constructed by placing the sensor(s) 220 in a desired location on the brake disc 110 or bicycle and then connecting the sensor(s) 220 to the non-sensing electronic components (210, 230, 240, 250). Typically, the non-sensing electronic components will be mounted on a PCB that is mounted on or held within the second part 122 of the housing. In one form, the sensor(s) 220 is/are wired to the rear of the PCB, which is attached to a mounting plate of the second part 122 of the housing.

The second part 122 of the housing may be attached to the brake disc 110 in any suitable manner. A method of attachment is to bolt the second part 122 of the housing to the brake disc 110 by inserting bolts through bolt apertures 125 provided in the second part 122 of the housing 120 and through corresponding apertures 115 provided in the brake disc 110. Other options include adhering the housing 120 or second part 122 of the housing to the brake disc 110 or over-moulding the housing or second part 122 of the housing to a portion of the brake disc. Once the second part 122 of the housing is secured in place and the electrical connections are secure, the first part 121 of the housing may be attached to the second part 122 to seal the electronic system 200 within the housing 120. The two parts 121, 122 may be attached in any suitable manner. For example, the two parts 121, 122 of the housing may be attached together using a snap fit arrangement, a plug and post arrangement, by joining the two parts together using fasteners such as screws, or by using some form of locking arrangement that is integral with the housing or that attaches to the housing.

In some forms, a seal, such as a gasket or the like, may be provided between the first and second parts 121, 122 of the housing to provide a watertight interior to the housing. In other forms, a seal may need to be added after the two parts 121, 122 are connected together. For example, a silicone bead may be placed over the connection between the first and second parts 121, 122 of the housing.

It is important that the housing 120 does not interfere with the fitting of the brake disc 110 to the bicycle. For this reason, it is necessary for the central region of the brake disc to be kept clear so that the disc can fit over the hub of the rear wheel of the bicycle.

In some forms, the housing 120 is made to be substantially slim to align with the brake disc as much as possible, as shown in FIG. 10. This arrangement is considered to be aesthetically pleasing and reduces the risk that the housing 120 could interfere with other parts of the bicycle or become caught on foliage for example.

Typically, the housing 120 will be made of plastic, but it is envisaged that other materials or combinations of materials may be used instead, such as metals or natural products.

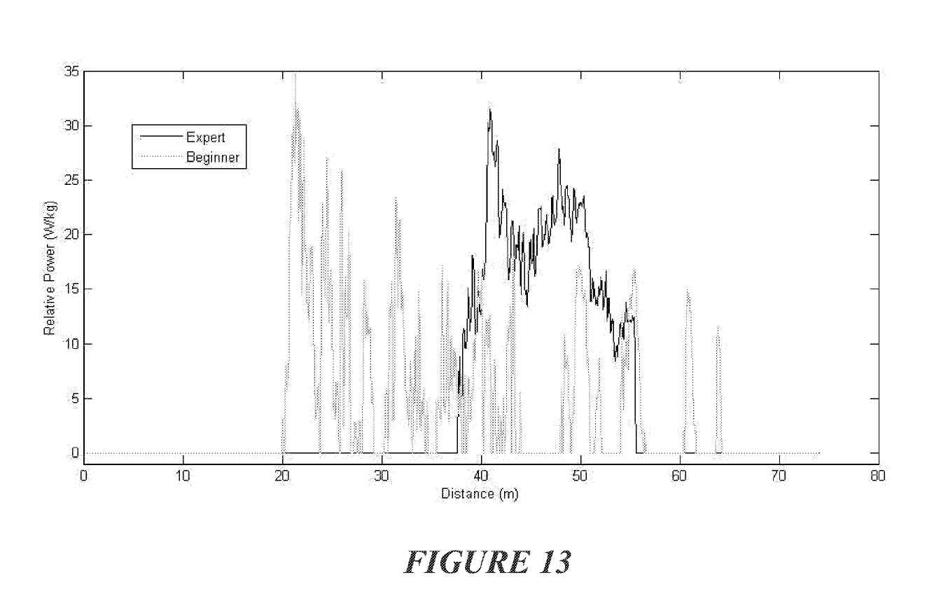

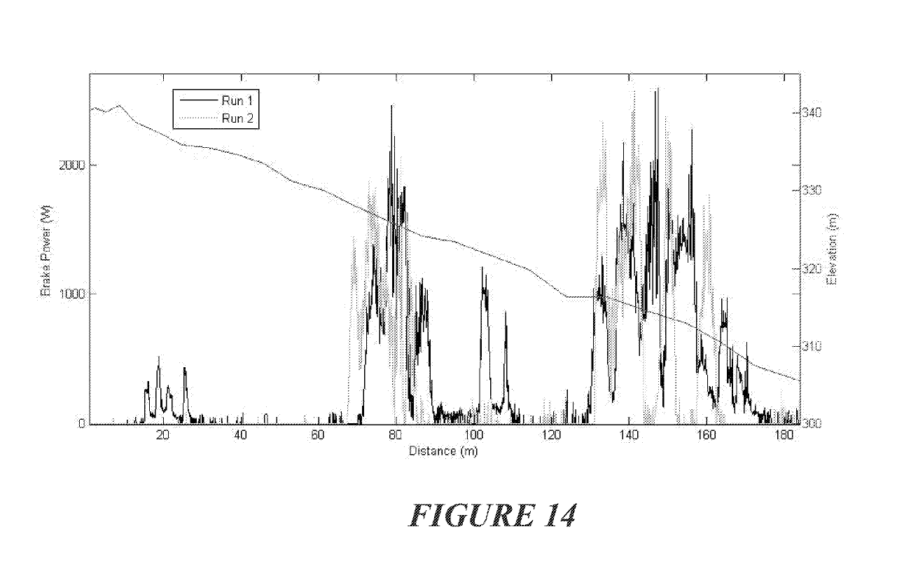

With reference to FIGS. 15 to 18, an alternative embodiment of a power meter 1100 is shown. The power meter in this embodiment is similar to the embodiment shown and described in relation to FIGS. 1 to 10, except as described below. Like numbers are used to indicate like parts, with the addition of 1000.

The housing 1120 may be a generally annular component that encircles the central aperture of the disc. FIG. 15 shows the housing 1120 is a hexagonal shape. The housing 1120 may have other shapes, such as circular. This embodiment has three strain gauge assemblies 1221 mounted on respective spokes of the housing, each assembly having two perpendicularly extending strain gauges. The three strain gauge assemblies 1221 are evenly angularly spaced. The strain gauges assemblies 1221 measure the strain experienced by the disc during braking. It will be appreciated that the power meter may have only one or two strain gauge assemblies 1221, or may have four or more strain gauge assemblies 1221.

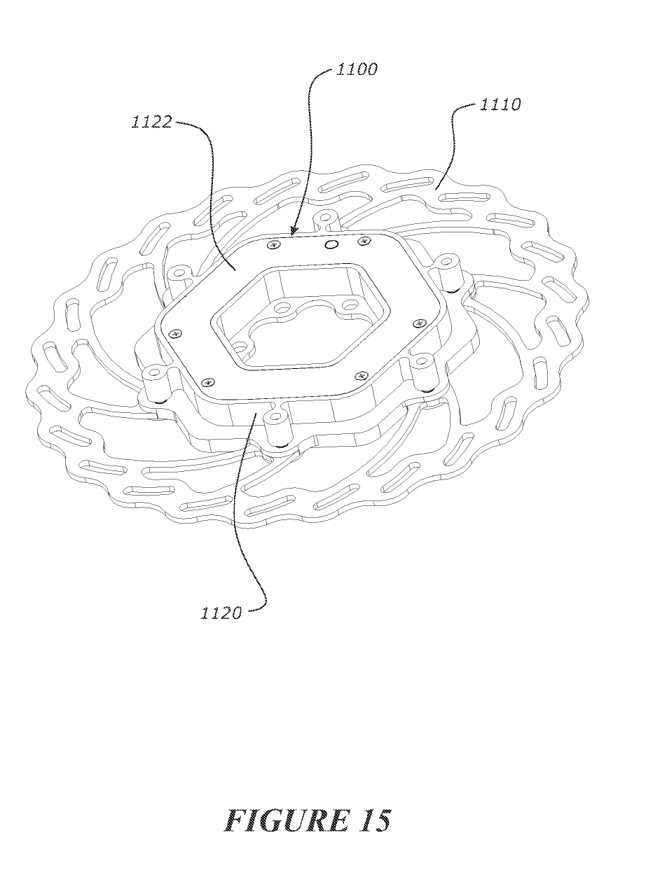

The housing 1120 also contains a battery 1160, a microprocessor 1161, electrical connectors 1162, and a PCB. The PCB is not shown in FIG. 17, but sits above the microprocessor and strain gauge assemblies 1221. The housing 1120 has a lid or cover 1122, attached by a plurality of fasteners. The housing 1120 may be additionally sealed.

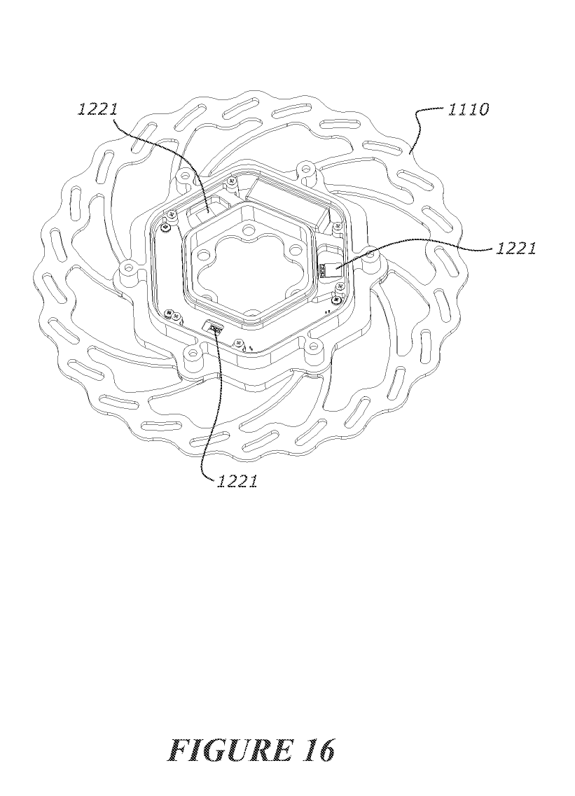

FIG. 18 is an exploded view showing the various components of the brake power meter. It can be seen from FIG. 18 that the housing 1120 in received in the space of the central part of the disc.

In another form, the power meter may be attached to the frame at a point where the frame is close to the brake component, such as at or near the wheel hub where the brake component is a rotor/brake disc. Suitable parts of the frame to which the power meter may be attached include, but are not limited to, the front forks, the seat stays, or the chain stays at the rear of the bicycle.

The strain gauge assemblies (e.g. the strain gauge assemblies 1121 of the brake power meter 1100 of FIGS. 15 to 18) may be used to determine the angular position of the brake. Data representing the angular position of the disc, together with data representing time, can be processed by a microprocessor 1161 to calculate the angular velocity of the disc.

The purpose of the strain gauge based angular detection is to identify the angular position of the brake power meter (mounted to the wheel/disc) solely by analysing the signals from the strain gauges mounted at the brake power meter spokes. This will eliminate any need for separate sensors (such as accelerometers or gyros), which will reduce production costs as well as power consumption.

The strain gauge based angular detection is based on the fact that the brake torque (applied in terms of the brake pad friction to the rotor surface) can be expressed as being proportional to the sum of the tangential pr radial forces at the brake power meter spokes. These forces are directly measured by the strain gauges mounted at each of the brake power meter spokes. However for a constant applied torque the individual strain gauge signals vary by a distinct curve, dependent on the angular position of the brake power meter. This curve is somewhat similar to a sine wave, but the exact definition of the curve depends on the geometry of the brake power meter. The curve is a measure of the individual strain gauge signal's contribution to the measured brake torque. This ‘contribution ratio’ curve is mapped for each strain gauge in the calibration process. Hence the contribution ratio is an expression for the ratio between the strain gauge signal and the applied torque.

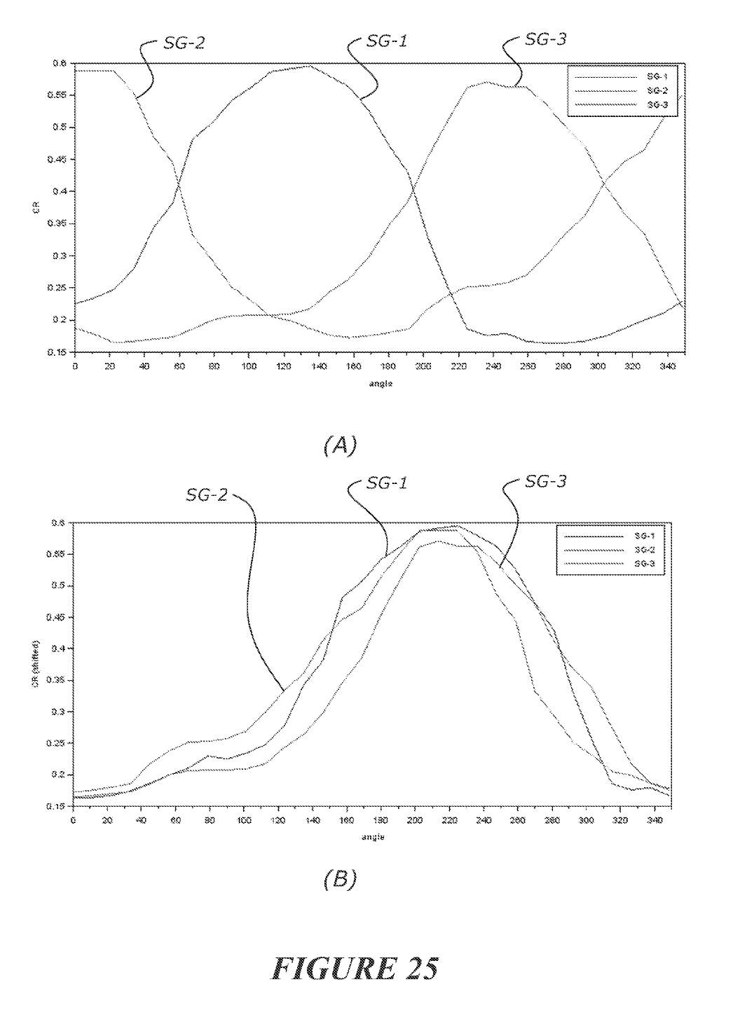

With reference to FIG. 25, when a constant torque is applied to the wheel while the brake is fully locked, and the wheel is positioned at various angular positions, each strain gauge assembly produces data that forms a contribution ratio, as demonstrated in FIG. 25 (A). The strain contribution ratios for each strain gauge are approximately phase shifted by the geometrical angle between the strain gauge positions with respect to the centre of revolution. In the particular example demonstrated below, three strain gauges are mounted on three spokes, so the phase shift angle is approximately 120 degrees. In FIG. 25 (B), the three contribution ratios are aligned such that their relative phases are approximately zero. This demonstrates the need to map each of the strain gauge's contribution ratios individually. This method will work for any number of spokes and strain gauges.

### Calibration

A calibration is performed by a method corresponding to the above description of the data in FIG. 25 (A), but with a precisely known torque. The output consists of coherent data series of angular position of the brake power meter and contribution ratios for each strain gauge. These data series are now saved as lookup tables that can be used to identify the angular position based on the set of contribution ratio values for each strain gauge.

### Operation

During usage of the brake power meter, the strain gauge signal for each brake power meter spoke is measured. From the sum of these signals the brake torque can be calculated; and from the brake torque the individual contribution ratios can be found. These measured contribution ratios are then compared to the calibrated contribution ratio lookup tables for the value. This is done in order to find the best match, from which the corresponding angular position can be identified by means of interpolation.

### Example

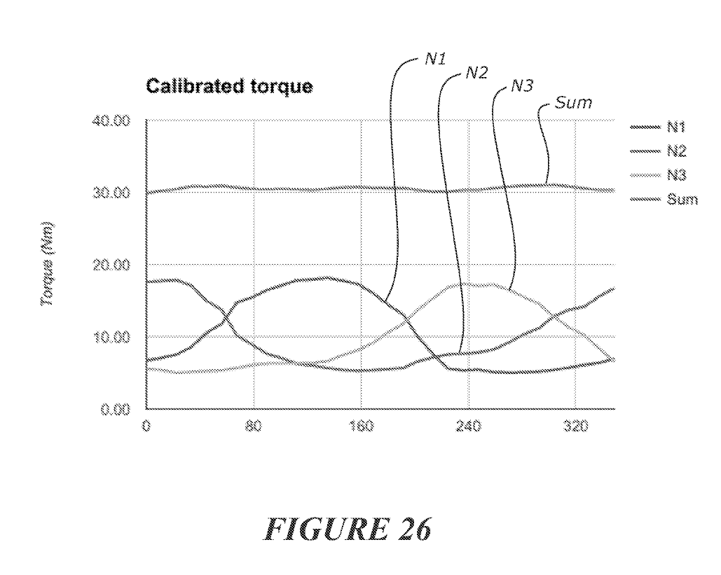

A calibration has been performed with a torque of approximately 31 Nm. Any suitable torque could be used. The data from this calibration is presented in FIG. 26. This figure verifies that the torque can at any angular position be described as being proportional to the sum of the strain gauge signals.

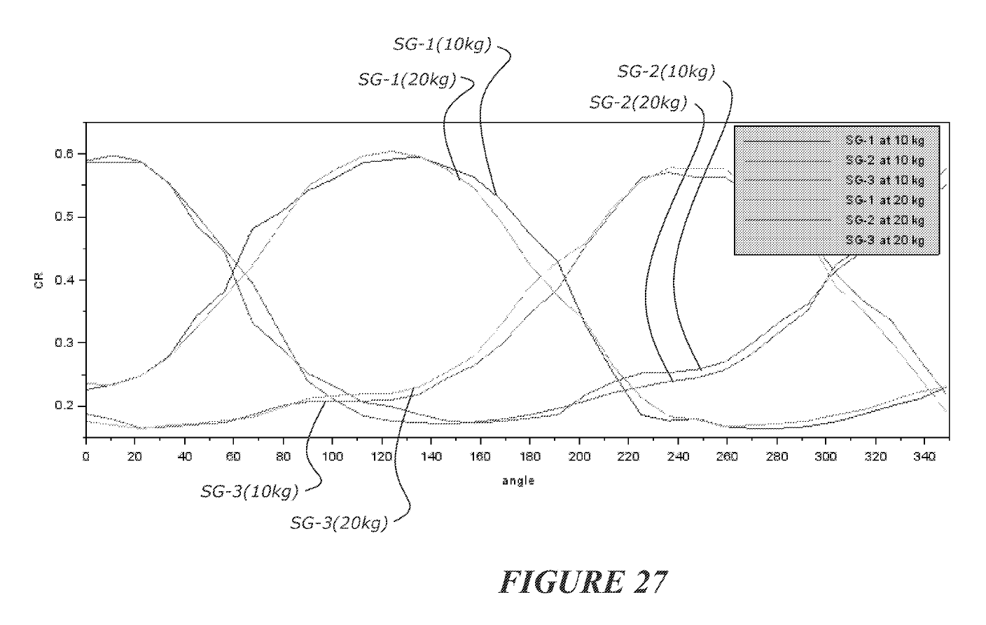

The brake power meter is then exposed to a torque of a different magnitude (this time of approximately 62 Nm, but again any suitable torque could be used). FIG. 27 shows the individual strain gauge signals from the 62 Nm experiment as well as the 31 Nm calibration in the same graph. Despite of the difference in applied torque the relation between angular position and the individual strain gauge contribution ratios remains approximately constant.

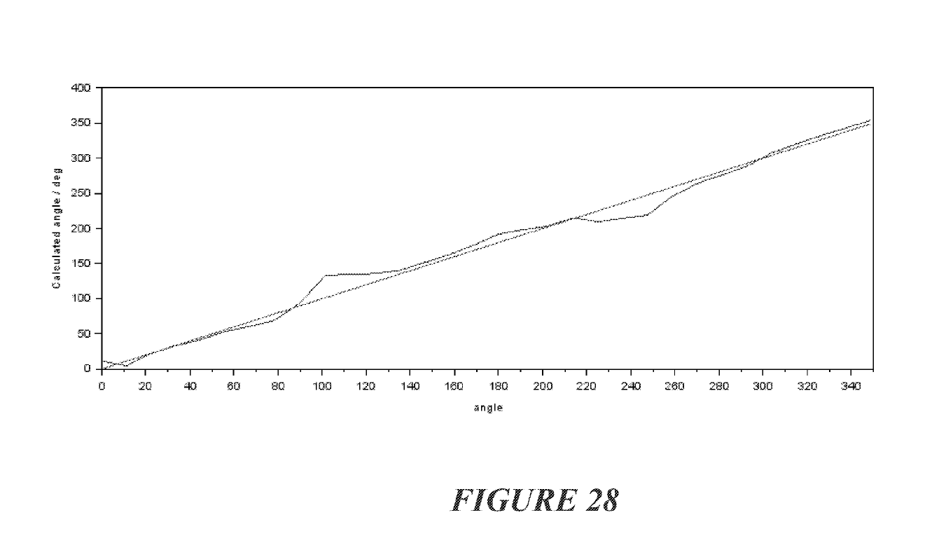

Based on the data from the 62 Nm experiment and the lookup table from the 31 Nm calibration, the angular position of the brake power meter for each of the measurements are computed by means of the routine described in the ‘Operation’ section. Since the actual angular position of the brake power meter was measured in parallel during the experiment, it is possible to compare the computed strain gauge based angular position to the actual measured angular position. The results are shown in FIG. 28.

The brake power meter may have four or more strain gauges and the data produced by the strain gauges can be used in the same way.

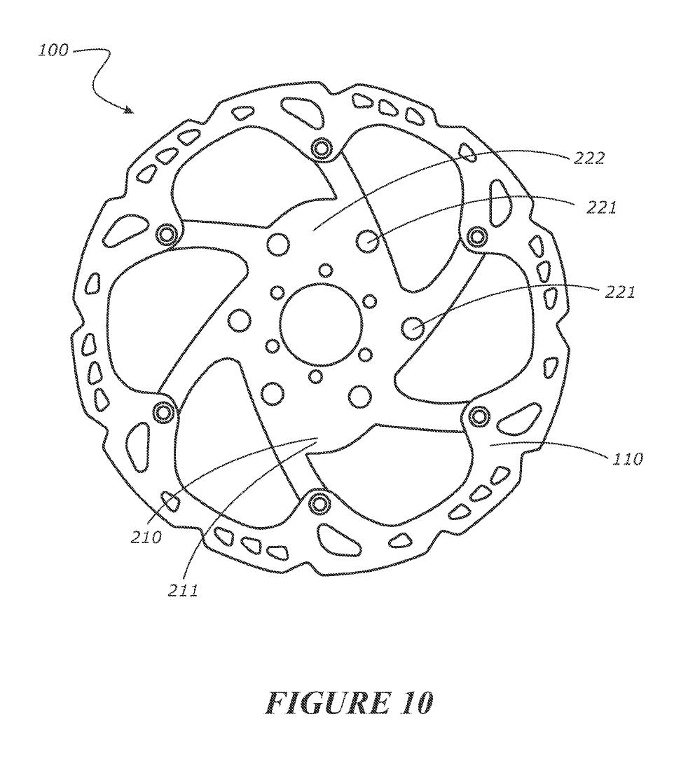

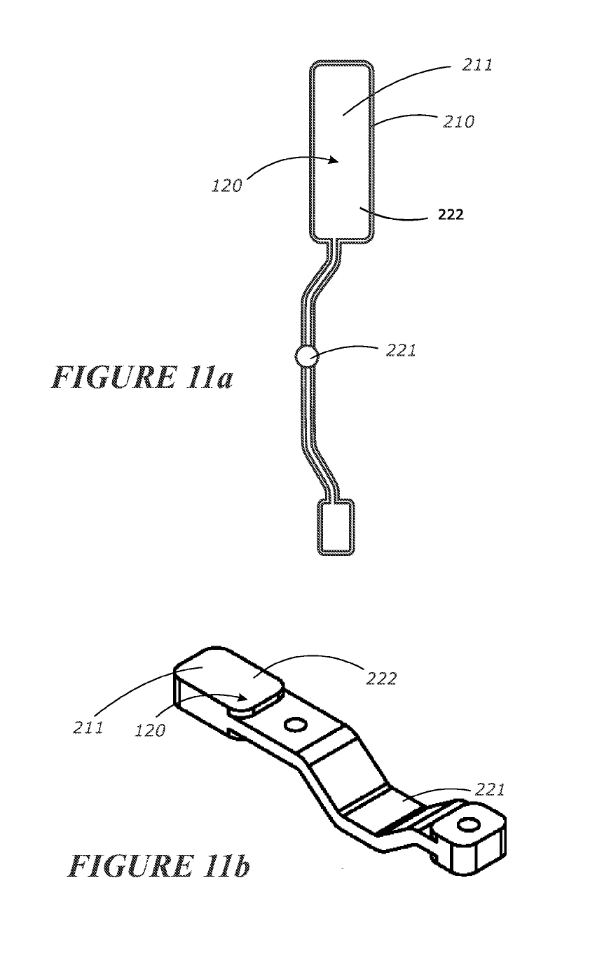

In one configuration, the power meter 120 of an embodiment of the disclosure may be located on or around the brake caliper 150, as shown in FIGS. 11a to 11d and FIG. 12. In this configuration, it is possible to use the power meter of the disclosure to make the same measurements of angular velocity, torque and power as those described above, regardless of whether the bicycle/vehicle uses rim brakes or disc brakes. In this form, the power meter may be configured to measure the work done by the caliper 150 in relation to the frame of the bicycle when the brakes are applied. For example, a first power meter may be attached to, or near, the caliper at the front wheel to measure the work done by the caliper 150 movement in relation to at least one of the front forks. A second power meter may be attached to, or near, the caliper at the rear wheel to measure the work done by the caliper movement in relation to at least one of the seat stays or chain stays.

The power meter 120 may be configured to be directly or indirectly attached to the bicycle frame 130. In one form, spacers 140 are located between the power meter 120 and the bicycle frame 130. The power meter 120 may be configured to be substantially rigidly connected to the frame 130 and caliper 150 of the respective brake. As the caliper moves during braking, the frame will experience a force, which is effectively a force of the brake pulling on the frame. As a result, the power meter 120 is caused to flex. This flexing movement may be measured by one or more strain gauge assemblies 221 in the power meter 120. It is possible to calculate the torque applied by the caliper based on the distance between the caliper and the centre of the wheel. By also measuring the angular velocity, it is possible to calculate the power lost during braking. The angular velocity may be provided by an accelerometer, gyroscope, magnetometer, or inertial measurement unit, as described above.

The power meter 120 may comprise a memory for storing measurement data received from one or more strain gauges and from an accelerometer, gyroscope, or magnetometer.

The power meter 120 retains the same features as described above when applied to the caliper 150. For example, the power meter 120 may comprise a control unit having a memory for storing measurement data received from one or more strain gauges and from an accelerometer, gyroscope, or magnetometer and/or for storing executable instructions for a processor. The control unit optionally comprises a processor, such as a microprocessor, configured to analyse sensor data received from the strain gauge(s) and accelerometer, gyroscope, magnetometer, or inertial measurement unit and to calculate the power loss (provided as output data) resulting from braking. The control system may comprise a clock and may be configured to cause the sensors to sense data at predetermined time intervals, such as every 0.1-0.5 seconds for example.

The power meter of this embodiment may be wired to one or more of the other electronic components or may communicate wirelessly with one or more of the other electronic components.

In one alternative embodiment, the power meter can be used with electric-assist bicycle systems. This embodiment would have features and operations similar to the embodiment that measures power in relation to the caliper. This embodiment may communicate wired or wirelessly. The power meter could be coupled to the electric-assist bicycle system to cut-off the electric motor when brakes are applied, which could be scalable to various thresholds or not (e.g. the electric bicycle motor stops any time brake power exceeds a threshold value such as 100 watts for example, or the torque exceeds a threshold value).

The power meter 120 may include a wire attached that would both supply power (from the battery of the motor) and provide feedback for control (to motor or other part)/recording (on the bike's existing on-board display unit). In this embodiment, power does not necessarily need to be supplied from within the unit, nor do there need to be wireless transmitters.

The power meter of this embodiment may be integrally formed with one or more the other components of the bicycle, such as the frame or caliper.

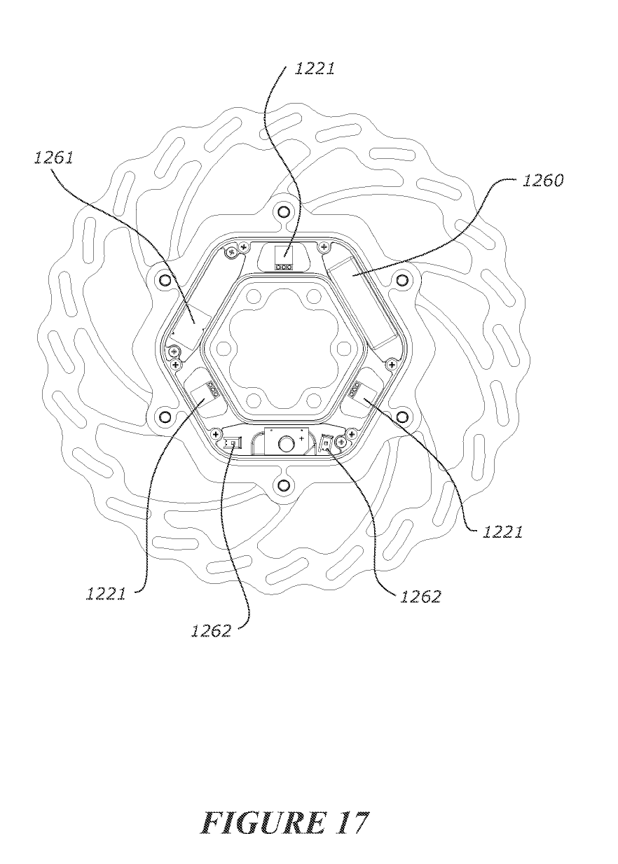

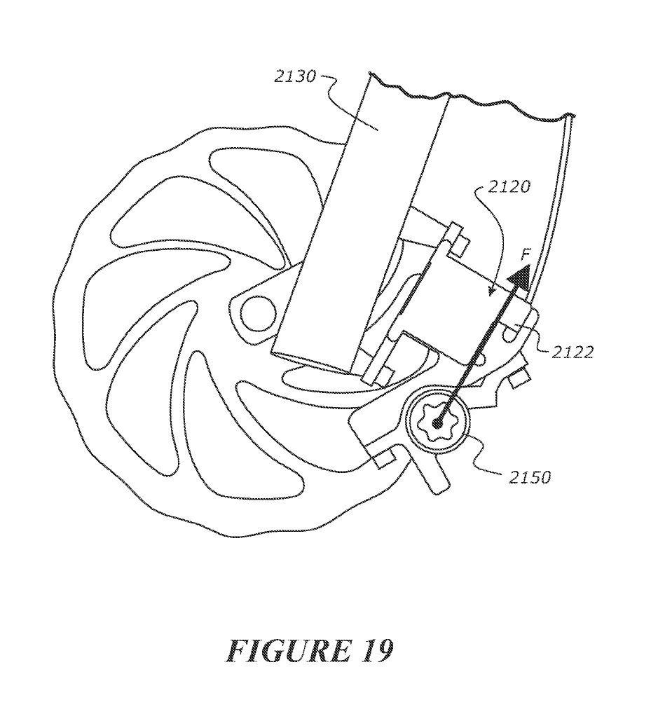

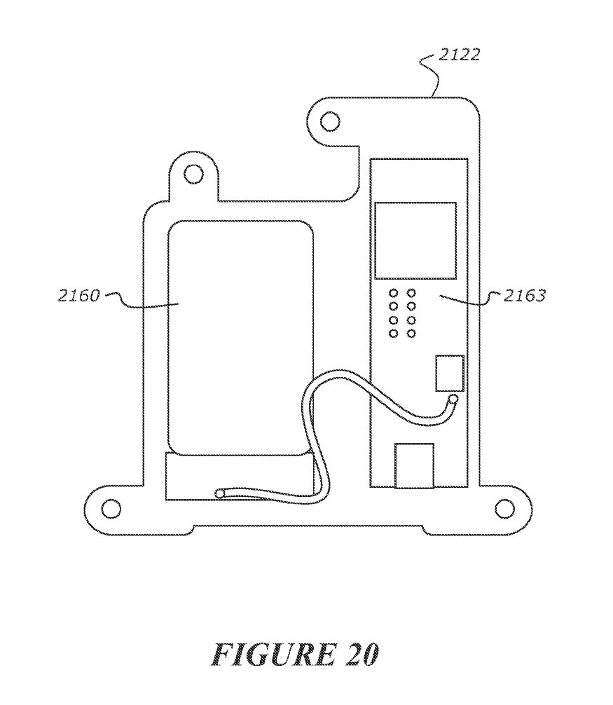

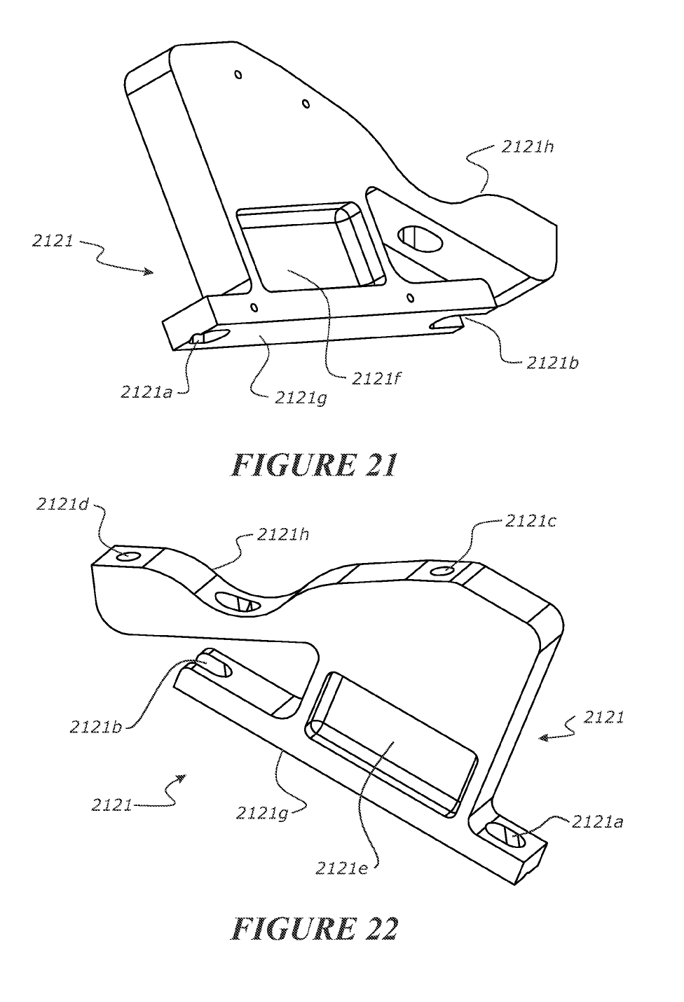

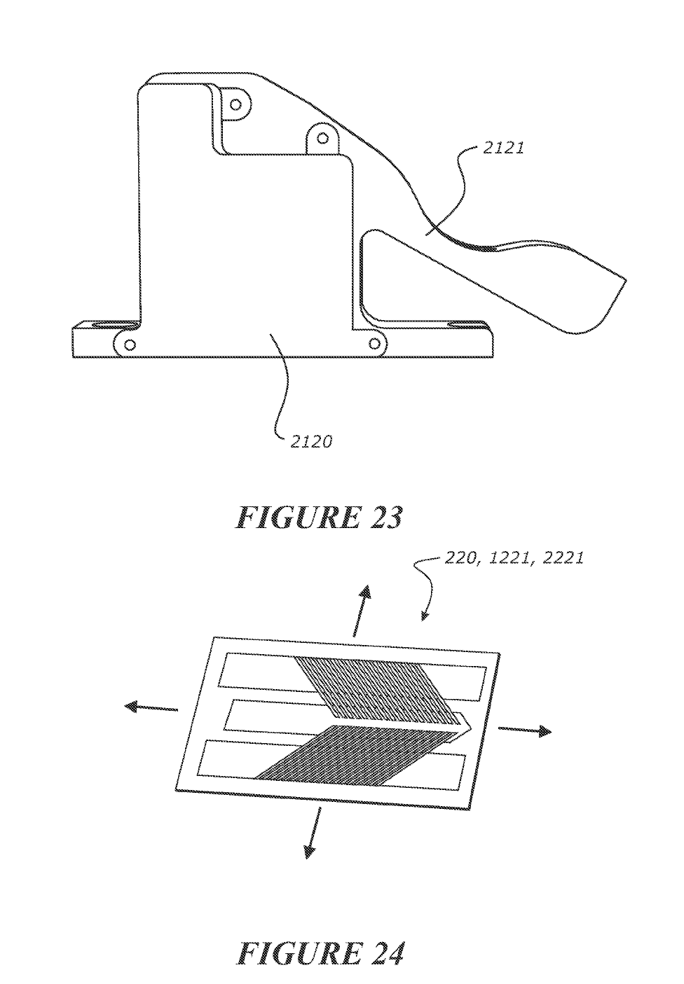

With reference to FIGS. 19 to 24, an alternative embodiment of a power meter is shown. The power meter in this embodiment is similar to the embodiment shown and described in relation to FIGS. 11a to 11d and FIG. 12, except as described below. Like numbers are used to indicate like parts, with the addition of 2000.

The power meter 2120 may be configured to be directly or indirectly attached to the bicycle frame 130. In the embodiment shown, the power meter is attached to the front fork 2130 between the front fork and the caliper 2150. The power meter 2120 is configured to be substantially rigidly connected to the front fork 2130 and caliper 2150 of the respective brake.

As the caliper 2150 moves during braking, the front fork 2130 will experience a force F, which is effectively a force of the brake pulling on the frame. As a result, the power meter 2120 will experience strain. This strain will be measured by one or more sensors such as strain gauges assemblies 2221 in the power meter 120. It is possible to calculate the torque applied by the caliper 2150 based on the distance between the caliper 2150 and the centre of the wheel. By also measuring the angular velocity, it is possible to calculate the power lost during braking. The angular velocity may be provided by an accelerometer, gyroscope, magnetometer, or inertial measurement unit, as described above.

The power meter 2120 has a housing with a body 2121. The body shape is designed to fit between the front fork 2130 and the front brake caliper 2150. The caliper 2150 may be positioned in a normal caliper position or a modified caliper position. The body has two extensions: one extension 2121g for attaching to the fork 2130 and one extension 2121h for attaching to the caliper 2150. The body 2121 has a generally square or rectangular shaped recess 2121e, 2121f on each side. The body has apertures 2121a, 2121b, 2121c, 2121d for receiving fasteners for attaching the body 2121 to the front fork 2130 and the caliper 2150.

The power meter 2120 may have one strain gauge assembly 2221. Alternatively, the power meter may have two or more strain gauge assemblies 2221. The strain gauge assembly 1221 is, in some embodiments, a single foil with two strain gauges. The strain gauges extend at 90 degrees relative to each other and each strain gauge has a length and a width. Each strain gauge measures strain along its length.

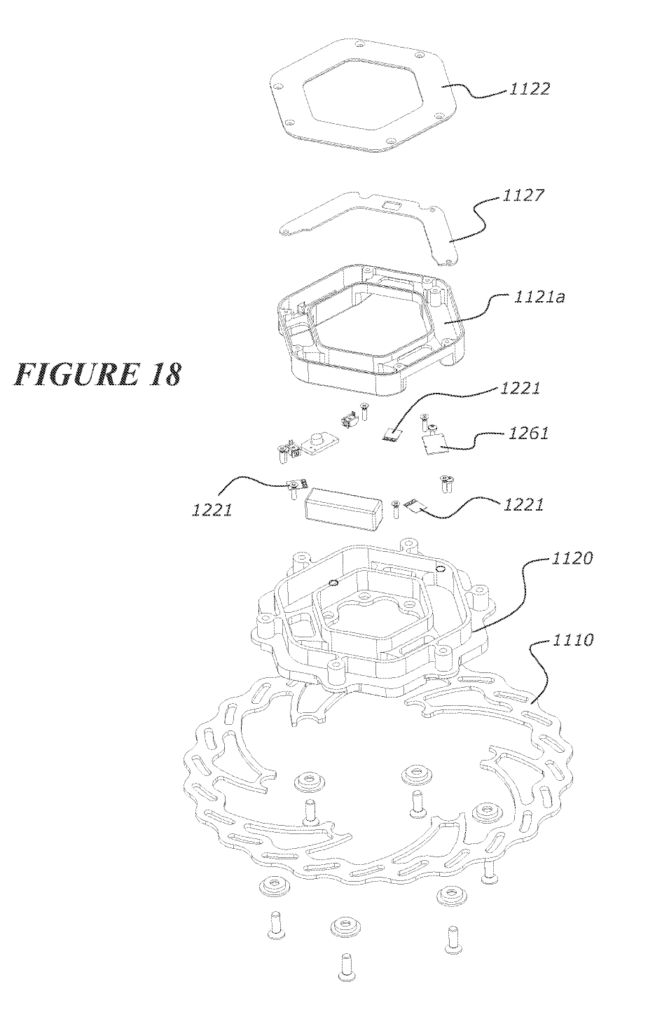

The strain gauge assembly 2221 is placed in the body, on the back wall that defines the recess 2121f. The strain gauge is covered by a cover 2122. FIG. 20 shows the cover 2122 housing a battery 2160, PCB 2163, and other electrical components necessary to receive and send electrical signals from the strain gauge to the control unit.

In one form, the power meter 100, 120, 1120, 2120 may comprise a user interface configured to display the power loss/output data in any suitable format, such as by graph or spreadsheet for example. In one form, the user interface may be wired to the power meter and may be mounted on the handlebars of the bicycle or at any other suitable location for a cyclist to view the display whilst riding. In another form, the power meter may comprise a transmitter to wirelessly transmit the output data to a remote user interface, such as by using Bluetooth technology for example. In another form, the power meter may comprise an output port by which the power meter may be connected to a remote user interface to upload measurement data from the power meter memory to the user interface.

Regardless of whether the user interface is part of the power meter or is separate from the power meter, the user interface may be configured to display the torque measurements and/or power measurements in any suitable format.

In another form, the power meter 100, 120, 1120, 2120 may be configured to transmit or upload the raw measurement data to a user interface comprising a processor that uses the raw data to calculate the power loss from braking and then to display this output data in any suitable format.

By mounting the power meter of the disclosure on the brake caliper, the power meter may be more sensitive to energy losses about the caliper/brake disc interface. However, the power meter may more exposed in this position than when it is mounted on the disc brake/rotor, leaving a higher likelihood of damage during an accident. It is envisaged that the power meter of the disclosure may be positioned at other suitable locations on a bicycle or other vehicle without departing from the scope of the disclosure.

Any of the embodiments described herein may harvest energy so the power meter does not require a charger. This embodiment has a magnet on the frame and an electric circuit on the brake disc or wheel. This system may also provide a value for the angle or angular velocity.

A power meter will typically be positioned at both the front and rear wheels of a bicycle to measure the torque applied by braking at each wheel, as shown in FIG. 12. One possible configuration is to attach a first power meter to a front fork, near the wheel hub of the front wheel, and a second power meter to a seat stay or chain stay, near the wheel hub of the rear wheel. Another possible configuration is to attach a power meter to each of the front and rear disc brakes. Of course other suitable mounting configurations for the power sensor are also possible without departing from the scope of the disclosure. FIG. 12 shows the embodiment shown and described in relation to FIGS. 19 to 23.

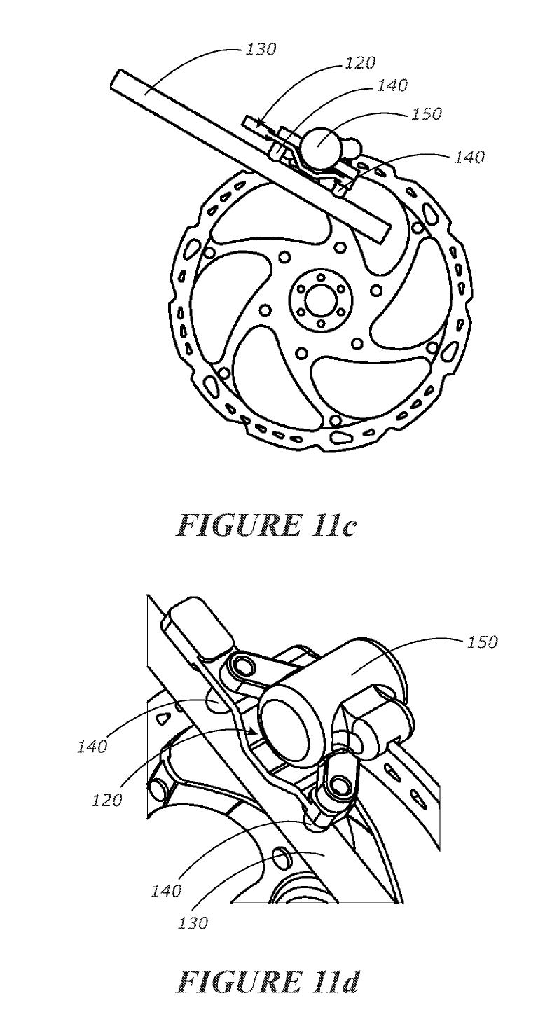

By using the power meter as a training tool, cyclists can develop skill to brake only when required and for as much as is required. In other words, a skilled cyclist may avoid slowing his or her bike too much or for too long and may therefore conserve the energy that would otherwise need to be exerted to bring the excessively slow bike back up to speed. FIG. 13 illustrates the difference in brake usage between a cyclist who has used the power meter to better develop skill at braking and a cyclist who is not as skilled. In this example, the skilled cyclist used 2,699 Joules of energy in the ride, whereas the unskilled cyclist used 3,051 Joules and was 2 seconds slower.

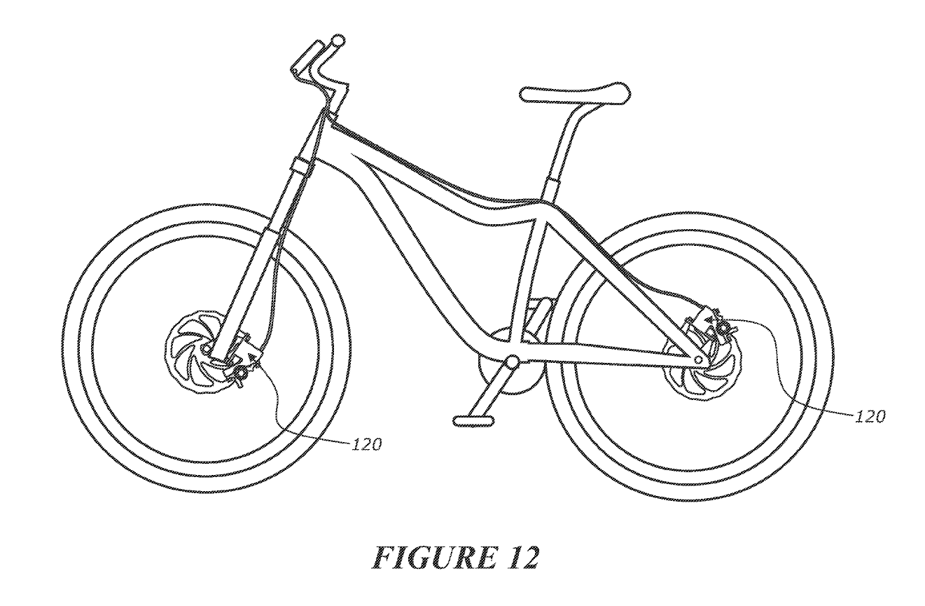

FIG. 14 shows an example of a cyclist completing a ride without the benefit of training with the power meter of the disclosure and then the same cyclist completing the same ride after using the power meter. After training with the power meter, the cyclist was 10 seconds faster on the ride.

### Advantages

The power meter of the disclosure provides a unique way of measuring the negative work and the braking skill of a rider or driver of a vehicle using disc brakes. By using the power meter, a cyclist may learn how much brake pressure to apply and for how long. It has been shown that by using the power meter of the disclosure and learning from the output results of the power meter over time, cyclists can improve their riding skill and reduce race times through effective and efficient braking.

Another advantage of the power meter of the disclosure is that it can be used to measure the impact of braking on the brake disc 110 itself. By directly measuring the braking impact on the brake disc 110 (rather than on the cranks, brake lines, or calipers) it is possible to obtain a more accurate power reading because losses in power that occur between the calipers and disc 110 do not need to be accounted for.

By measuring the impact of braking at the calipers, it is possible to obtain a power reading for bicycles and other vehicles that use calipers, such as rim brakes. However, it will be appreciated that the caliper embodiment may also be used with a disc brake.

The power meter of the disclosure is also quick and easy to install, especially when installation involves swapping an existing brake disc for the power meter comprising a brake disc 110.

1. A brake power measuring device for use with a vehicle comprising a braking system, the device comprising:
one or more sensors comprising one or more strain sensors for sensing strain applied to a brake disc during braking;
a housing attachable to, or attached to, the brake disc, the housing housing electronics comprising the one or more strain sensors, wherein the one or more strain sensors are configured to generate electronic signals when force is applied to the brake disc during braking; and
a control unit configured to:
calculate power losses as a result of braking, using torque and angular velocity calculated on the basis of readings from the one or more sensors, and
produce the power loss calculations as output data.

2. The brake power measuring device of claim 1, further comprising a speed sensor for measuring the angular velocity of the brake disc during braking.

3. The brake power measuring device of claim 2, wherein the speed sensor is housed in the housing.

4. The brake power measuring device of claim 1, wherein the one or more strain sensors determines the angular position of the brake disc and the control unit is further configured to receive the angular position and calculate the angular velocity based on the angular position.

5. The brake power measuring device of claim 1, wherein the housing is a substantially enclosed housing.

6. The brake power measuring device of claim 1, further comprising a transmitter for transmitting the output data to a user interface.

7. The brake power measuring device of claim 6, wherein the transmitter is a Bluetooth transmitter or ANT transmitter.

8. The brake power measuring device of claim 1, further comprising a memory for storing the output data.

9. The brake power measuring device of claim 1, further comprising an amplifier configured to amplify readings from the one or more strain sensors before the readings are received by the control unit.

10. The brake power measuring device of claim 2, wherein the speed sensor comprises an accelerometer for measuring the angular velocity of the disc.

11. The brake power measuring device of claim 2, wherein the speed sensor comprises a magnetometer for measuring the angular velocity of the disc.

12. The brake power measuring device of claim 1, further comprising an inertial measurement unit, which comprises an accelerometer, magnetometer, and/or gyroscope to measure the angular velocity of the disc.

13. The brake power measuring device of claim 1, wherein the one or more strain sensors comprises one or more strain gauges.

14. The brake power measuring device of claim 1, wherein the device further comprises a brake disc to which the housing is attached.

15. The brake power measuring device of claim 1, wherein the device is configured to be used with a bicycle, car, truck, or motorbike that comprises a disc braking system.

16. A brake power measuring device for use with a vehicle comprising a frame, a wheel rotatable relative to the frame, and a braking system associated with the wheel, the device comprising:
a housing attachable to the frame near a brake caliper of the braking system, the housing housing one or more force sensing elements for measuring a force experienced by the frame during braking;
a speed sensor for measuring the angular velocity of the wheel during braking;
a control unit configured to:
receive the measured force and the angular velocity,
calculate power losses as a result of braking, based on the measured force and angular velocity, and
produce the power loss calculations as output data.

17. The brake power measuring device of claim 16, further comprising a transmitter for transmitting the output data to a user interface.

18. The brake power measuring device of claim 17, wherein the transmitter is a Bluetooth transmitter or ANT transmitter.

19. The brake power measuring device of claim 16, further comprising a memory for storing the output data.

20. The brake power measuring device of claim 16, further comprising an amplifier configured to amplify readings from the one or more force sensing elements before the readings are received by the control unit.

21. The brake power measuring device of claim 16, wherein the speed sensor comprises an accelerometer for measuring the angular velocity of the wheel.

22. The brake power measuring device of claim 16, wherein the speed sensor comprises a magnetometer for measuring the angular velocity of the wheel.

23. The brake power measuring device of claim 16, further comprising an inertial measurement unit, which comprises an accelerometer, magnetometer, and/or gyroscope to measure the angular velocity of the wheel.

24. The brake power measuring device of claim 16, wherein the device is attachable between, or attached between, a brake calliper and a part of the frame.

25. The brake power measuring device of claim 16, wherein the device is an integral or removable part of the caliper.

26. The brake power measuring device of claim 16, wherein the device is an integral or removable part of the frame.

27. The brake power measuring device of claim 16, wherein the device is configured to be used with a bicycle, car, truck, or motorbike that comprises a disc braking system.
